(19) United States
(12) Patent Application Publication
(10) Pub. No.: US 2023/0316971 A1
(43) Pub. Date: Oct. 5, 2023

(54) COMPENSATION METHOD AND DEVICE FOR DISPLAY PANEL

(71) Applicant: KUNSHAN GO-VISIONOX OPTO-ELECTRONICS CO., LTD, Kunshan (CN)

(72) Inventors: Keun Chul KIM, Kunshan (CN); Tao TANG, Kunshan (CN); Huize LI, Kunshan (CN)

(73) Assignee: KUNSHAN GO-VISIONOX OPTO-ELECTRONICS CO., LTD, Kunshan (CN)

(21) Appl. No.: 18/332,135

(22) Filed: Jun. 9, 2023

Related U.S. Application Data
(63) Continuation of application No. PCT/CN2021/122303, filed on Sep. 30, 2021.

(30) Foreign Application Priority Data
Dec. 21, 2020 (CN) 202011519924.4

(51) Int. Cl. G09G 3/00

(52) U.S. Cl. CPC G09G 3/006; G09G 2320/0233; G09G 2320/0271; G09G 2330/12

(57) ABSTRACT

A compensation method and device for a display panel. The compensation method for a display panel includes acquiring a plurality of test grayscales of a to-be-tested display panel, performing a grayscale extension on the test grayscales to determine a plurality of test mapping grayscales corresponding to the test grayscales; acquiring, by using a camera, actual display brightness of each of the test mapping grayscales and actual display chroma of each of the test mapping grayscales; and determining a grayscale compensation formula of each display region of the at least two display regions of the display panel according to target display brightness of each of the test mapping grayscales, target display chroma of each of the plurality of test mapping grayscales, the actual display brightness of each of the test mapping grayscales, and the actual display chroma of each of the test mapping grayscales.

### CROSS REFERENCE TO RELATED APPLICATIONS

The application is a continuation of International Patent Application No. PCT/CN2021/122303, filed on Sep. 30, 2021, which claims priority to Chinese Patent Application No. 202011519924.4, filed on Dec. 21, 2020, the disclosures of which are incorporated herein by reference in their entireties.

### TECHNICAL FIELD

Embodiments of the present application relate to display technology and, in particular, to a compensation method and device for a display panel.

### BACKGROUND

An organic light-emitting diode (OLED) display panel is a self-luminous display panel. OLED display panels have been increasingly widely used in a variety of high-performance display fields due to advantages including thinness, lightness, high brightness, wide viewing angles, high response speeds, and wide temperature ranges.

In an image display process, an OLED display panel is prone to an uneven display, which is a research and development issue that has been concerned for a long period in the display panel industry.

### SUMMARY

The following is a summary of the subject matter described herein in detail. This summary is not intended to limit the scope of the claims.

The present application provides a compensation method and device for a display panel to improve the display evenness of the display panel.

In a first aspect, embodiments of the present application provide a compensation method for a display panel. The method includes the steps below.

The display panel includes at least two display regions. Grayscale compensation formulas of the at least two display regions are not exactly the same. The method includes the steps below.

A plurality of test grayscales of the display panel are acquired, a grayscale extension is performed on the plurality of test grayscales to determine a plurality of test mapping grayscales corresponding to the plurality of test grayscales.

Actual display brightness of each of the plurality of test mapping grayscales and actual display chroma of each of the plurality of test mapping grayscales are acquired by using a camera.

A grayscale compensation formula of each display region of the display panel is determined according to the target display brightness of each of the plurality of test mapping grayscales, the target display chroma of each of the plurality of test mapping grayscales, the actual display brightness of each of the plurality of test mapping grayscales, and the actual display chroma of each of the plurality of test mapping grayscales.

In a second aspect, embodiments of the present application provide a compensation device for a display panel. The display panel includes at least two display regions. Grayscale compensation formulas of the at least two display regions are not exactly the same. The device includes a grayscale extension module, a brightness and chroma acquisition module, and a compensation formula determination module.

The grayscale extension module is configured to acquire a plurality of test grayscales of the display panel, and to perform a grayscale extension on the plurality of test grayscales to determine a plurality of test mapping grayscales corresponding to the plurality of test grayscales.

The brightness and chroma acquisition module is configured to acquire, by using a camera, actual display brightness of each of the plurality of test mapping grayscales and actual display chroma of each of the plurality of test mapping grayscales.

The compensation formula determination module is configured to determine a grayscale compensation formula of each display region of the display panel according to the target display brightness of each of the plurality of test mapping grayscales, the target display chroma of each of the test mapping grayscales, the actual display brightness of each of the test mapping grayscales, and the actual display chroma of each of the test mapping grayscales.

### BRIEF DESCRIPTION OF DRAWINGS

FIG. 1 is a flowchart of a compensation method for a display panel according to this embodiment.

FIG. 2 is a diagram of the display panel according to this embodiment.

FIG. 3 is a diagram of a compensation device of a display panel according to this embodiment.

### DETAILED DESCRIPTION

The present application is further described in detail in conjunction with the drawings and the embodiments. It is to be understood that the embodiments set forth below are intended to illustrate and not to limit the present application. Additionally, it is to be noted that for ease of description, only part, not all, of structures related to the present application are illustrated in the drawings.

As mentioned in the background, a display panel in the related art is prone to a brightness deviation in a display process. The applicant found through research that the reason for this situation lies in that an IR drop has different effects on different positions of the display panel in a display, leading to different drive currents of sub-pixels at different positions, making the display brightness of the display panel uneven, and affecting the display effect.

On the basis of the preceding situation, this embodiment provides the technical solutions below.

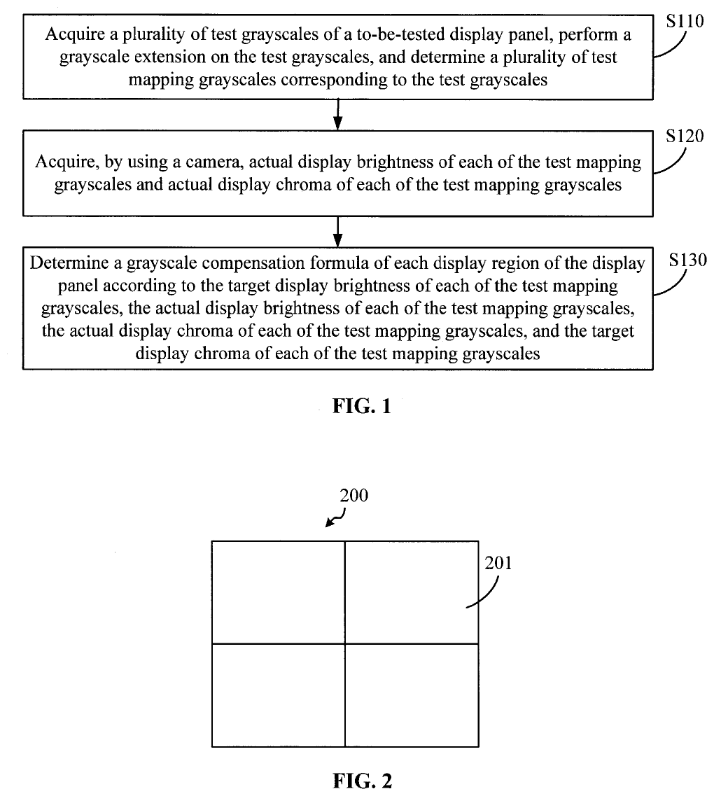

This embodiment provides a compensation method for a display panel. FIG. 1 is a flowchart of a compensation method for a display panel according to this embodiment. FIG. 2 is a diagram of the display panel according to this embodiment. Referring to FIGS. 1 and 2, this method includes the steps below.

The display panel 200 includes at least two display regions 201. Grayscale compensation formulas of the at least two display regions 201 are not exactly the same.

The method includes the steps below.

In S110, a plurality of test grayscales of a to-be-tested display panel are acquired, a grayscale extension is performed on the test grayscales to determine a plurality of test mapping grayscales corresponding to the test grayscales.

The test grayscales are in one-to-one correspondence with the test mapping grayscales. A plurality of test grayscales may be arranged to test the display panel. Exemplarily, the test grayscales may be arranged to include, for example, grayscale 32, grayscale 64, grayscale 128, and grayscale 255. The grayscale extension performed on a test grayscale of the test grayscales refers to increasing the maximum display brightness corresponding to the maximum grayscale of the display panel and re-determining a grayscale corresponding to the test grayscale according to the target display brightness corresponding to the test grayscale, that is, determining the test mapping grayscale corresponding to the test grayscale. The same applies to the grayscale extension performed on the test grayscales, i.e., a grayscale extension is performed on each test grayscales to determine a test mapping grayscale corresponding to the test grayscale. Exemplarily, the test grayscale may be extended by one level. The test grayscale is mapped to a new grayscale number. For example, a range of grayscale 0 to grayscale 255 (8 bits) is extended to a range of grayscale 0′ to grayscale 1023′ (10 bits). The brightness corresponding to 1023′ is greater than the brightness corresponding to the original grayscale 255. Then grayscale 0 is mapped to grayscale 0′, and grayscale 255 is mapped to a grayscale smaller than grayscale 1023′, for example, grayscale 1000′. In this case, the maximum grayscale is improved to implement the compensation for any test grayscale of the display panel. For example, in this case, a test grayscale of a certain region in an image is already grayscale 255. However, the brightness of the grayscale needs to be improved to compensate for an uneven display. If the grayscale extension is not performed, no data greater than grayscale 255 can be used for brightness improvement. After the grayscale extension is performed, grayscale has a compensation improvement range of grayscale 1001′ to grayscale 1023′.

Optionally, the step in which the grayscale extension is performed on the test grayscale and the test mapping grayscale corresponding to the test grayscale is determined includes that the test mapping grayscale is determined according to a formula that G1=G*A/Gd. G1 denotes the test mapping grayscale. G denotes the test grayscale. A is a positive integer smaller than Gd. Gd denotes the maximum value of the test grayscale. A may be determined according to needs and is not specifically limited in this embodiment. Exemplarily, A=250. Test grayscale 0 to test grayscale 255 may be mapped to test mapping grayscale 0′ to test mapping grayscale 250′. Grayscale 255 has a compensation improvement range of grayscale 250′ to grayscale 255′.

In S120, actual display brightness of each of the test mapping grayscales and actual display chroma of each of the test mapping grayscales are acquired by using a camera.

Specifically, when optical measurement equipment in the related art collects display data, the collection area is relatively small, making display data of a plurality of display regions get collected through a plurality of collections. The use of the camera enables display data of the display regions to be collected simultaneously. Compared with the method of collecting display data of each region in sequence in the related art, this method implements a faster collection of display data. Moreover, the use of the camera enables the actual display brightness and the actual display chroma to be collected simultaneously when the to-be-tested display panel displays the test mapping grayscale.

In S130, a grayscale compensation formula of each display region of the display panel is determined according to the target display brightness of each of the test mapping grayscales, the actual display brightness of each of the test mapping grayscales, the actual display chroma of each of the test mapping grayscales, and the target display chroma of each of the test mapping grayscales.

Specifically, the target display brightness may include the target display brightness of a white image and the target display brightness corresponding to each sub-pixel. The actual display brightness is actual display brightness of the white image. The actual display brightness of each of sub-pixels of each color may be determined according to the actual display brightness and the actual display chroma. When the target display brightness only includes the target display brightness of the white image, the target display brightness of each of sub-pixels of each color may be determined according to the target display brightness of the white image and the target display chroma. A grayscale compensation value of each of sub-pixels of each color is determined according to a difference between the target display brightness and actual display brightness of each of sub-pixels of each color. The grayscale compensation values corresponding to the test mapping grayscales are fitted to obtain grayscale compensation formula.

Additionally, the display panel may be divided into at least two display regions according to different IR-drop degrees. Exemplarily, the display panel is divided into n*m display regions. n is an integer greater than or equal to 2, and m is an integer greater than or equal to 1. Alternatively, n is an integer greater than or equal to 1, and m is an integer greater than or equal to 2. As the display panel is divided into at least two different display regions, grayscale compensation formulas are determined for different display regions respectively, making the compensation of each display region more accurate, resulting in a better compensation effect, and reducing the determination difficulty of the compensation formulas.

In the solutions of this embodiment, actual display brightness and actual display chroma when a to-be-tested display panel displays a test mapping grayscale are acquired by using a camera. In this case, display data of a plurality of display regions can be collected simultaneously, and the actual display brightness and the actual display chroma can be collected simultaneously. Moreover, the display panel is divided into at least two display regions. Grayscale compensation formulas are determined for the display regions respectively, making the compensation of each display region more accurate, resulting in a better compensation effect and a better display evenness of the display panel after compensation, and reducing the determination difficulty of the compensation formulas. Additionally, a grayscale compensation formula of each display region of the display panel is determined according to the target display brightness of each of a plurality of test mapping grayscales, the actual display brightness of each of the test mapping grayscales, the actual display chroma of each of the test mapping grayscales, and the target display chroma of each of the test mapping grayscales. In this case, the uneven display is compensated, and the white balance of the display panel can be adjusted at the same time, further improving the compensation effect on the display panel.

Optionally, the step in which the grayscale compensation formula of each display region of the display panel is determined according to the target display brightness of each of the test mapping grayscales, the actual display brightness of each of the test mapping grayscales, the actual display chroma of each of the test mapping grayscales, and the target display chroma of each of the test mapping grayscales includes the steps below.

An extended gamma curve corresponding to sub-pixels of each color is determined according to the target display brightness of each of the test mapping grayscales, the target display chroma of each of the test mapping grayscales, and an extended gamma formula.

An actual display grayscale of sub-pixels of each color is determined according to the extended gamma curve, the actual display brightness of each of the test mapping grayscales, and the actual display chroma of each of the test mapping grayscales. By this way, actual display grayscales corresponding to the test mapping grayscales of each color are determined.

The grayscale compensation formula of each display region of the display panel is determined according to actual display grayscales corresponding to the test mapping grayscales.

Specifically, the target display brightness corresponding to each of sub-pixels of each color may be determined according to the target display brightness and the target display chroma. For sub-pixels of a certain color, a test grayscale is G. A test mapping grayscale is G1. The target display brightness corresponding to the test grayscale G and the test mapping grayscale G1 is LG. The maximum grayscale after the grayscale extension is GD. The target display brightness corresponding to GD is LGD. Then LG=G1^{γ}*LGD/(GD)^{γ}. γ denotes a gamma value. In this case, the extended gamma curve is that Ln=(n/Gd)^{γ}*LGD. n denotes a grayscale value. The actual display brightness of each of sub-pixels of each color may be determined according to the actual display brightness and the actual display chroma. An actual display grayscale corresponding to each test mapping grayscale may be determined according to the actual display brightness and the extended gamma curve. A difference between an actual display grayscale and a test mapping grayscale may be determined as a grayscale compensation value. A grayscale fitting formula is determined according to a plurality of actual display grayscales.

Optionally, the step in which the grayscale compensation formula of each display region of the display panel is determined according to the actual display grayscales corresponding to the test mapping grayscales includes the steps below.

A grayscale compensation value is determined according to a difference between an actual display grayscale of each sub-pixel and a test mapping grayscale of the each sub-pixel.

A grayscale compensation formula corresponding to sub-pixels of the same color in the same display region is determined according to a grayscale compensation value corresponding to each test grayscale of the sub-pixels of the color in the display region.

Specifically, an average value of a grayscale compensation value corresponding to each test grayscale of sub-pixels of the same color in the same display region may be calculated so that the grayscale compensation formula is fitted according to a plurality of average values. Additionally, a compensation formula of a sub-pixel may be calculated according to a plurality of grayscale compensation values corresponding to a plurality of test mapping grayscales of the sub-pixel. Compensation formulas of a plurality of sub-pixels of the same color in the same display region are fitted so that a grayscale compensation formula of the sub-pixels of the color in the display region is determined.

Optionally, the step in which the grayscale compensation formula of each display region of the display panel is determined according to the target display brightness of each of the test mapping grayscales, the actual display brightness of each of the test mapping grayscales, the actual display chroma of each of the test mapping grayscales, and the target display chroma of each of the test mapping grayscales includes the steps below.

An actual display brightness corresponding to each test mapping grayscale of each sub-pixel is determined according to the actual display brightness of each of the test mapping grayscales and the actual display chroma of each of the test mapping grayscales.

A grayscale compensation formula of each sub-pixel is determined according to the target display brightness of each of multiple test mapping grayscales of each sub-pixel and the actual display brightness of each of multiple test mapping grayscales of each sub-pixel.

A plurality of grayscale compensation formulas of a plurality of sub-pixels of the same color in the same display region are fitted to determine a grayscale compensation formula of sub-pixels of each color in the display region.

Specifically, an actual display curve of each sub-pixel may be fitted according to the actual display brightness of each of multiple test mapping grayscales of each sub-pixel. A grayscale value corresponding to the target display brightness is found on the actual display curve. The grayscale value is determined as a grayscale value to be input to a sub-pixel for displaying the target display brightness. A difference between the grayscale value and a test mapping grayscale is determined as a grayscale compensation value. Grayscale compensation values corresponding to multiple test mapping grayscales of the same sub-pixel are determined using the preceding method. A grayscale compensation formula corresponding to the sub-pixel may be fitted according to the grayscale compensation values. Therefore, a grayscale compensation formula of each sub-pixel is determined. A plurality of grayscale compensation formulas of a plurality of sub-pixels of the same color are fitted to determine a grayscale compensation formula of sub-pixels of each color in the same display region. In this case, the actual display curve of each sub-pixel is fitted and the grayscale value corresponding to the target display brightness is found on the actual display curve so that the grayscale value is determined. With this arrangement, the display brightness after compensation is equal to the target display brightness, resulting in a better compensation effect on the display panel.

Optionally, the step in which the grayscale compensation formula of each display region of the display panel is determined according to the target display brightness of each of the test mapping grayscales, the actual display brightness of each of the test mapping grayscales, the actual display chroma of each of the test mapping grayscales, and the target display chroma of each of the test mapping grayscales includes the steps below.

An actual display brightness corresponding to each test mapping grayscale of each sub-pixel is determined according to the actual display brightness of each of the test mapping grayscales and the actual display chroma of each of the test mapping grayscales.

The grayscale compensation formula of each display region is determined according to an average value of the actual display brightness corresponding to each test mapping grayscale of a plurality of sub-pixels of the same color in each display region, the target display brightness, and the target display chroma.

Specifically, the target display brightness of each of sub-pixels of each color is determined according to the target display brightness and the target display chroma. The compensation formula of sub-pixels of the same color is determined according to the actual display brightness and target display brightness corresponding to each test mapping grayscale of the sub-pixels of the color. Exemplarily, an average actual display curve of sub-pixels of each color in the region may be fitted according to the actual display brightness. The grayscale value corresponding to the target display brightness is found on the curve. A difference between the grayscale value and a test mapping grayscale is determined as a grayscale compensation value. A grayscale compensation formula of the sub-pixels of the color is determined according to a plurality of grayscale compensation values. In this embodiment, the grayscale compensation formula of the sub-pixels of the color is determined according to an average value of the actual display brightness of each of sub-pixels of each color in the same display region, saving the calculation amount and improving the efficiency of determining the compensation formula.

Optionally, the grayscale compensation formula is that Gk=a*G1+b. a is a positive number. Gk denotes a grayscale compensation value. G1 denotes the test mapping grayscale.

Specifically, the use of the linear grayscale compensation formula in the display process of the display panel may determine a grayscale compensation value rapidly, improving the speed of compensation.

Exemplarily, the preceding formula may be stored in the display panel. When the display panel displays an image, a grayscale extension is performed first on an input grayscale to obtain an input mapping grayscale. A grayscale compensation value is determined according to the input mapping grayscale and the grayscale compensation formation. A compensation input grayscale is determined according to the grayscale compensation value. The compensation input grayscale is input into sub-pixels to implement image display. Through use that the display unevenness of the display panel by using the method of this embodiment reaches more than 90%.

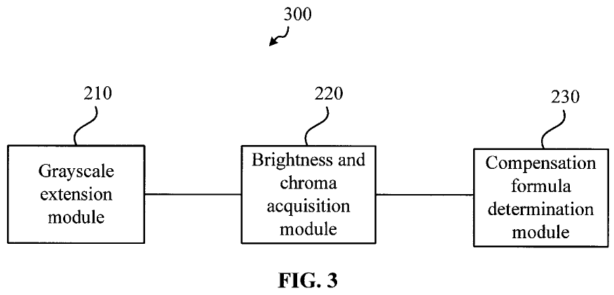

This embodiment further provides a compensation device for a display panel. The display panel includes at least two display regions. Grayscale compensation formulas of the at least two display regions are not exactly the same. FIG. 3 is a diagram of a compensation device of a display panel according to this embodiment. Referring to FIG. 3, the compensation device 300 for a display panel includes a grayscale extension module 210, a brightness and chroma acquisition module 220, and a compensation formula determination module 230.

The grayscale extension module 210 is configured to acquire a plurality of test grayscales of the display panel, and to perform a grayscale extension on the plurality of test grayscales to determine a plurality of test mapping grayscales corresponding to the test grayscale. The test grayscales are in one-to-one correspondence with the test mapping grayscales.

The brightness and chroma acquisition module 220 is configured to acquire, by using a camera, actual display brightness of each of the test mapping grayscales and actual display chroma of each of the test mapping grayscales.

The compensation formula determination module 230 is configured to determine a grayscale compensation formula of each display region of the display panel according to the target display brightness of each of the test mapping grayscales, the target display chroma of each of the test mapping grayscales, the actual display brightness of each of the test mapping grayscales, and the actual display chroma of each of the test mapping grayscales.

Optionally, the compensation formula determination module 230 includes a brightness and curve determination unit, an actual grayscale determination unit, and a formula determination unit.

The brightness and curve determination unit is configured to determine an extended gamma curve corresponding to sub-pixels of each color according to a gamma formula, the target display brightness of each of the test mapping grayscales, and the target display chroma of each of the test mapping grayscales.

The actual grayscale determination unit is configured to determine an actual display grayscale of the sub-pixels of each color according to the extended gamma curve, the actual display brightness of each of the test mapping grayscales, and the actual display chroma of each of the test mapping grayscales. By this way, actual display grayscales corresponding to the test mapping grayscales of each color are determined.

The formula determination unit is configured to determine the grayscale compensation formula of each display region of the display panel according to actual display grayscales corresponding to the test mapping grayscales.

Optionally, the formula determination unit includes a compensation value determination sub-unit and a formula determination sub-unit.

The compensation value determination sub-unit is configured to determine a grayscale compensation value according to a difference between an actual display grayscale of each sub-pixel and a test mapping grayscale of the each sub-pixel.

The formula determination sub-unit is configured to determine, according to a grayscale compensation value corresponding to each test grayscale of sub-pixels of the same color in the same display region, a grayscale compensation formula corresponding to the sub-pixels of the color in the display region.

The compensation device for a display panel provided in this embodiment and the compensation method for a display panel provided in any embodiment of the present application belong to the same concept and have the same beneficial effects. For technical details not described in detail in this embodiment, reference may be made to the compensation method for a display panel provided in any embodiment of the present application.

It is to be noted that the above are only preferred embodiments of the present application and the principles used therein. It is to be understood by those skilled in the art that the present application is not limited to the specific embodiments described herein. Those skilled in the art can make various apparent variations, adaptions, combinations, and substitutions without departing from the scope of the present application. Therefore, while the present application has been described in detail via the preceding embodiments, the present application is not limited to the preceding embodiments and may include more other equivalent embodiments without departing from the concept of the present application. The scope of the present application is determined by the scope of the appended claims.

What is claimed is:

1. A compensation method for a display panel, wherein
the display panel comprises at least two display regions, and grayscale compensation formulas of the at least two display regions are not exactly same; and
the method comprises:
acquiring a plurality of test grayscales of the display panel, and performing a grayscale extension on the plurality of test grayscales to determine a plurality of test mapping grayscales corresponding to the plurality of test grayscales;
acquiring, by using a camera, actual display brightness of each of the plurality of test mapping grayscales and actual display chroma of each of the plurality of test mapping grayscales; and
determining a grayscale compensation formula of each of the at least two display regions of the display panel according to target display brightness of each of the plurality of test mapping grayscales, target display chroma of each of the plurality of test mapping grayscales, the actual display brightness of each of the plurality of test mapping grayscales, and the actual display chroma of each of the plurality of test mapping grayscales.

2. The method according to claim 1, wherein the determining a grayscale compensation formula of each of the at least two display regions of the display panel according to target display brightness of each of the plurality of test mapping grayscales, target display chroma of each of the plurality of test mapping grayscales, the actual display brightness of each of the plurality of test mapping grayscales, and the actual display chroma of each of the plurality of test mapping grayscales, comprises:
determining an extended gamma curve corresponding to a plurality of sub-pixels of each color according to a gamma formula, the target display brightness of each of the plurality of test mapping grayscales, and the target display chroma of each of the plurality of test mapping grayscales;
determining an actual display grayscale of the plurality of sub-pixels of the each color according to the extended gamma curve, the actual display brightness of each of the plurality of test mapping grayscales, and the actual display chroma of each of the plurality of test mapping grayscales; and
determining the grayscale compensation formula of the each display region of the display panel according to a plurality of actual display grayscales corresponding to the plurality of test mapping grayscales.

3. The method according to claim 2, wherein the determining the grayscale compensation formula of the each display region of the display panel according to a plurality of actual display grayscales corresponding to the plurality of test mapping grayscales, comprises:
determining a grayscale compensation value according to a difference between an actual display grayscale of each sub-pixel and a test mapping grayscale of the each sub-pixel; and
determining, according to a grayscale compensation value corresponding to each test grayscale of a plurality of sub-pixels of a same color in a same display region of the at least two display regions, a grayscale compensation formula corresponding to the plurality of sub-pixels of the color in the display region.

4. The method according to claim 1, wherein the determining a grayscale compensation formula of each of the at least two display regions of the display panel according to target display brightness of each of the plurality of test mapping grayscales, target display chroma of each of the plurality of test mapping grayscales, the actual display brightness of each of the plurality of test mapping grayscales, and the actual display chroma of each of the plurality of test mapping grayscales, comprises:
determining actual display brightness corresponding to each test mapping grayscale of each sub-pixel according to the actual display brightness of each of the plurality of test mapping grayscales and the actual display chroma of each of the plurality of test mapping grayscales, wherein the each test mapping grayscale is among the plurality of test mapping grayscales;
determining a grayscale compensation formula of the each sub-pixel according to target display brightness of each of multiple test mapping grayscales of the each sub-pixel and actual display brightness of each of the multiple test mapping grayscales of the each sub-pixel, wherein the multiple test mapping grayscales are among the plurality of test mapping grayscales; and
fitting a plurality of grayscale compensation formulas of a plurality of sub-pixels of a same color in a same display region of the at least two display regions to determine a grayscale compensation formula of a plurality of sub-pixels of the each color in the display region.

5. The method according to claim 1, wherein the determining a grayscale compensation formula of each of the at least two display regions of the display panel according to target display brightness of each of the plurality of test mapping grayscales, target display chroma of each of the plurality of test mapping grayscales, the actual display brightness of each of the plurality of test mapping grayscales, and the actual display chroma of each of the plurality of test mapping grayscales, comprises:
determining actual display brightness corresponding to each test mapping grayscale of each sub-pixel according to the actual display brightness of each of the plurality of test mapping grayscales and the actual display chroma of each of the plurality of test mapping grayscales, wherein the each test mapping grayscale is among the plurality of test mapping grayscales; and
determining the grayscale compensation formula of the each display region according to an average value of actual display brightness corresponding to each test mapping grayscale of a plurality of sub-pixels of a same color in the each display region, the target display brightness, and the target display chroma, wherein the each test mapping grayscale is among the plurality of test mapping grayscales.

6. The method according to claim 1, wherein the performing a grayscale extension on the plurality of test grayscales to determine a plurality of test mapping grayscales corresponding to the plurality of test grayscales, comprises:
determining a test mapping grayscale of the plurality of test mapping grayscales according to a formula that G1=G*A/Gd, wherein G1 denotes the test mapping grayscale, G denotes a test grayscale of the plurality of test grayscales, A is a positive integer smaller than Gd, and Gd denotes a maximum value of the test grayscale.

7. The method according to claim 1, wherein the performing a grayscale extension on the plurality of test grayscales to determine a plurality of test mapping grayscales corresponding to the plurality of test grayscales, comprises:
increasing a maximum display brightness corresponding to a maximum grayscale of the display panel; and
re-determining a grayscale corresponding to a test grayscale of the plurality of test grayscales according to target display brightness corresponding to the test grayscale as a test mapping grayscale corresponding to the test grayscale.

8. The method according to claim 1, wherein
the grayscale compensation formula is that Gk=a*G1+b, wherein a is a positive number, Gk denotes a grayscale compensation value, and G1 denotes a test mapping grayscale of the plurality of test mapping grayscales.

9. The method according to claim 1, wherein the target display brightness comprises target display brightness of a white image and target display brightness corresponding to each sub-pixel, and the actual display brightness comprises actual display brightness of the white image.

10. The method according to claim 9, wherein
in a case where the target display brightness comprises the target display brightness of the white image, the determining a grayscale compensation formula of each of the at least two display regions of the display panel according to target display brightness of each of the plurality of test mapping grayscales, target display chroma of each of the plurality of test mapping grayscales, the actual display brightness of each of the plurality of test mapping grayscales, and the actual display chroma of each of the plurality of test mapping grayscales, comprises:
determining target display brightness of each of a plurality of sub-pixels of each color according to the target display brightness of the white image and the target display chroma;
determining a grayscale compensation value of each of the plurality of sub-pixels of each color according to a difference between target display brightness of each of the plurality of sub-pixels of each color and actual display brightness of each of the plurality of sub-pixels of each color; and
fitting a plurality of grayscale compensation values corresponding to the test mapping grayscales to obtain the grayscale compensation formula.

11. A compensation device for a display panel, wherein
the display panel comprises at least two display regions, grayscale compensation formulas of the at least two display regions are not exactly same, and the device comprises:
a grayscale extension module configured to acquire a plurality of test grayscales of the display panel, and to perform a grayscale extension on the plurality of test grayscales to determine a plurality of test mapping grayscales corresponding to the plurality of test grayscales;
a brightness and chroma acquisition module configured to acquire, by using a camera, actual display brightness of each of the plurality of test mapping grayscales and actual display chroma of each of the plurality of test mapping grayscales; and
a compensation formula determination module configured to determine a grayscale compensation formula of each of the at least two display regions of the display panel according to target display brightness of each of the plurality of test mapping grayscales, target display chroma of each of the plurality of test mapping grayscales, the actual display brightness of each of the plurality of test mapping grayscales, and the actual display chroma of each of the plurality of test mapping grayscales.

12. The compensation device according to claim 11, wherein the compensation formula determination module comprises:
a brightness and curve determination unit configured to determine an extended gamma curve corresponding to a plurality of sub-pixels of each color according to a gamma formula, target display brightness of each of the plurality of test mapping grayscales, and the target display chroma of each of the plurality of test mapping grayscales;
an actual grayscale determination unit configured to determine an actual display grayscale of the plurality of sub-pixels of the each color according to the extended gamma curve, the actual display brightness of each of the plurality of test mapping grayscales, and the actual display chroma of each of the plurality of test mapping grayscales; and
a formula determination unit configured to determine the grayscale compensation formula of the each display region of the display panel according to a plurality of actual display grayscales corresponding to the plurality of test mapping grayscales.

13. The device according to claim 12, wherein the formula determination unit comprises:
a compensation value determination sub-unit configured to determine a grayscale compensation value according to a difference between an actual display grayscale of each sub-pixel and a test mapping grayscale of the each sub-pixel; and
a formula determination sub-unit configured to determine, according to a grayscale compensation value corresponding to each test grayscale of a plurality of sub-pixels of a same color in a same display region of the at least two display regions, a grayscale compensation formula corresponding to the plurality of sub-pixels of the color in the display region.

14. The compensation device according to claim 12, wherein the formula determination unit is configured to:
determine actual display brightness corresponding to each test mapping grayscale of each sub-pixel according to the actual display brightness of each of the plurality of test mapping grayscales and the actual display chroma of each of the plurality of test mapping grayscales, wherein the each test mapping grayscale is among the plurality of test mapping grayscales;
determine a grayscale compensation formula of the each sub-pixel according to target display brightness of each of multiple test mapping grayscales of the each sub-pixel and actual display brightness of each of the multiple test mapping grayscales of the each sub-pixel, wherein the multiple test mapping grayscales are among the plurality of test mapping grayscales; and
fit a plurality of grayscale compensation formulas of a plurality of sub-pixels of a same color in a same display region of the at least two display regions to determine a grayscale compensation formula of a plurality of sub-pixels of the each color in the display region.

15. The compensation device according to claim 11, wherein the compensation formula determination module is further configured to:
determine actual display brightness corresponding to each test mapping grayscale of each sub-pixel according to the actual display brightness of each of the plurality of test mapping grayscales and the actual display chroma of each of the plurality of test mapping grayscales, wherein the each test mapping grayscale is among the plurality of test mapping grayscales; and
determine the grayscale compensation formula of the each display region according to an average value of actual display brightness corresponding to each test mapping grayscale of a plurality of sub-pixels of a same color in the each display region, the target display brightness, and the target display chroma, wherein the each test mapping grayscale is among the plurality of test mapping grayscales.

16. The compensation device according to claim 11, wherein the grayscale extension module is further configured to:
determine a test mapping grayscale of the plurality of test mapping grayscales according to a formula that G1=G*A/Gd, wherein G1 denotes the test mapping grayscale, G denotes a test grayscale of the plurality of test grayscales, A is a positive integer smaller than Gd, and Gd denotes a maximum value of the test grayscale.

17. The compensation device according to claim 11, wherein the grayscale extension module is further configured to:
increase a maximum display brightness corresponding to a maximum grayscale of the display panel; and
re-determine a grayscale corresponding to a test grayscale of the plurality of test grayscales according to target display brightness corresponding to the test grayscale as a test mapping grayscale corresponding to the test grayscale.

18. The compensation device according to claim 11, wherein
the grayscale compensation formula is that Gk=a*G1+b, wherein a is a positive number, Gk denotes a grayscale compensation value, and G1 denotes a test mapping grayscale of the plurality of test mapping grayscales.

19. The compensation device according to claim 11, wherein the target display brightness comprises target display brightness of a white image and target display brightness corresponding to each sub-pixel, and the actual display brightness comprises the actual display brightness of the white image.

20. The compensation device according to claim 19, wherein
in a case where the target display brightness comprises the target display brightness of the white image, the compensation formula determination module is further configured to:
determine target display brightness of each of a plurality of sub-pixels of each color according to the target display brightness of the white image and the target display chroma;
determine a grayscale compensation value of each of the plurality of sub-pixels of each color according to a difference between target display brightness of each of the plurality of sub-pixels of each color and actual display brightness of each of the plurality of sub-pixels of each color;
and fit a plurality of grayscale compensation values corresponding to the test mapping grayscales to obtain the grayscale compensation formula.
